(19) United States
(12) Patent Application Publication
(10) Pub. No.: US 2023/0399146 A1
(43) Pub. Date: Dec. 14, 2023

(54) CONTAINER WITH ZIPPER TAPE, METHOD FOR MANUFACTURING CONTAINER WITH ZIPPER TAPE, AND DEVICE FOR MANUFACTURING CONTAINER WITH ZIPPER TAPE

(71) Applicant: IDEMITSU UNITECH CO.,LTD., Tokyo (JP)

(72) Inventors: Takumi TODAKA, Tokyo (JP); Tomohiko TAMAOKI, Tokyo (JP)

(73) Assignee: IDEMITSU UNITECH CO.,LTD., Tokyo (JP)

(21) Appl. No.: 18/036,277

(22) PCT Filed: Nov. 11, 2021
(86) PCT No.: PCT/JP2021/041443

§ 371 Date: May 10, 2023

(30) Foreign Application Priority Data
Nov. 11, 2020 (JP) 2020-188086

(51) Int. Cl. B65D 33/25; B65D 33/00; B29D 5/10

(52) U.S. Cl. CPC B65D 33/2541; B65D 33/005; B29D 5/10

(57) ABSTRACT

Provided is a container provided with a zipper tape including: a container body including at least a first area and a second area that are opposed to each other; a zipper tape including a first base strip being at least partially bonded to the first area, a second base strip being at least partially bonded to the second area, a first engagement portion and a second engagement portion respectively protruding from the first base strip and the second base strip and being engageable with each other; and a hinge is provided at at least one position that satisfies m/n<0.25, where “n” represents a length of an opening portion of the container body, and “m” represents a distance from the hinge to an inner end portion of the opening portion in a longitudinal direction of the zipper tape.

### TECHNICAL FIELD

The invention relates to a container provided with a zipper tape, a method of manufacturing a container provided with a zipper tape, and a device configured to manufacture a container provided with a zipper tape.

### BACKGROUND ART

A bag provided with a zipper tape is widely used for packaging various articles such as medicines and foods. One of advantages of such a bag provided with a zipper tape is easy openability and resealablility. A user is able to disengage the zipper tape and open the bag by pulling both surfaces of the bag to which the zipper tape is bonded in such a manner as to separate the surfaces from each other. The user is also able to engage the zipper tape and reseal the bag by pressing both the surfaces of the bag in such a manner as to bring the surfaces close to each other.

Upon opening the above-described bag provided with a zipper tape, each of both surfaces of the bag is generally pinched with fingers and pulled in a direction perpendicular to a longitudinal direction of the zipper tape. In this case, both hands of the user are necessary for opening. In contrast, Patent Literature 1 discloses a technique that allows a user to open a bag by sliding alternately each of both surfaces of the bag along a longitudinal direction of a zipper tape. In this case, it is possible to disengage the zipper tape and open the bag by performing the following operation. The user pinches and twists each of both surfaces of the bag with fingers of one hand, specifically, a thumb and an index finger of one hand.

The technique of Patent Literature 1 describes the opening operation for disengaging the zipper tape by bending only one surface of the bag on both sides of a part where the user pinches. However, a situation in which such an opening operation is easily performable is limited to a case where rigidity of the zipper tape is relatively low and the zipper tape is soft. Accordingly, in a case where the zipper tape includes a rigid material in order to resist internal pressure of the bag or to prevent unintended opening caused by external force by strengthening the engagement, it is not easy to bend the zipper tape. It is thus difficult to employ the technique of Patent Literature 1.

In view of the above, a technique disclosed in Patent Literature 2 has been proposed. Patent Literature 2 discloses a bag provided with a zipper tape, including: a bag body having at least one pair of facing surfaces; and an elongated zipper tape whose cross sectional profile includes at least one pair of base strips each bonded to corresponding one of the pair of facing surfaces, and at least one pair of engagement portions that are protruded from the respective base strips and mutually engageable, in which the zipper tape is provided with hinges at two positions in a longitudinal direction.

### CITATION LIST

### Patent Literature(s)

Patent Literature 1: US Patent Application Publication No. 2003/0138171
Patent Literature 2: International Publication No. WO2019/111911

### SUMMARY OF THE INVENTION

### Problem(s) to be Solved by the Invention

According to a configuration described in Patent Literature 2, it is possible to easily open a bag by sliding each of both sides of the bag in a longitudinal direction of a zipper tape, irrespective of rigidity of the zipper tape. However, for example, in a case of preventing unintended opening caused by external force, engagement of the zipper tape becomes relatively weak in a hinge portion. This can lead to a situation in which a function of preventing the unintended opening is not sufficiently exhibited.

It is therefore an object of the invention to provide a container provided with a zipper tape, a method of manufacturing a container provided with a zipper tape, and a device of manufacturing a container provided with a zipper tape that make it possible to prevent engagement strength in a hinge portion from becoming relatively weak, in which the container provided with a zipper tape is able to be opened easily by causing each of both surfaces of the container to be slid in a longitudinal direction of a zipper tape.

### Means for Solving the Problem(s)

[1] According to an aspect of the invention, a container provided with a zipper tape includes: a container body including at least a first area and a second area that are opposed to each other; a zipper tape including a first base strip being at least partially bonded to the first area, a second base strip being at least partially bonded to the second area, a first engagement portion and a second engagement portion respectively protruding from the first base strip and the second base strip and being engageable with each other; and a hinge is provided at at least one position that satisfies m/n<0.25, where “n” represents a length of an opening portion of the container body, and “m” represents a distance from the hinge to an inner end portion of the opening portion in a longitudinal direction of the zipper tape.
[2] In the container according to [1], the hinge is provided at a position where the distance m to the inner end portion of the opening portion is less than or equal to 20 mm.
[3] In the container according to [1] or [2], an engagement strength of the zipper tape in a part that does not include the hinge is more than or equal to 26 N/50 mm.
[4] In the container according to any one of [1] to [3], the hinge has a thin portion or a cut provided in the first engagement portion and the second engagement portion.
[5] In the container according to any one of [1] to [3], the hinge has a punched hole that penetrates through the first base strip, the second base strip, the first engagement portion, and the second engagement portion.
[6] In the container according to any one of [1] to [5], an antislip structure is provided on at least one of: a surface of the first area which is opposed to a surface to which the first base strip is bonded; or a surface of the second area which is opposed to a surface to which the second base strip is bonded.
[7] In the container according to any one of [1] to [6], the container body has a mouth on one side in a width direction of the zipper tape, and the first base strip is not bonded to the first area on a side close to the mouth relative to the first engagement portion in the width direction.
[8] In the container according to any one of [1] to [7], the zipper tape further includes a third engagement portion and a fourth engagement portion respectively protruding from the first second base strip and the second base strip and being engageable with each other.
[9] In the container according to any one of [1] to [8], the container body has a bag shape.

[10] According to another aspect of the invention, a method of manufacturing a container provided with a zipper tape includes: feeding a zipper tape including a first base strip, a second base strip, a first engagement portion, and a second engagement portion, the first engagement portion and the second engagement portion respectively protruding from the first base strip and the second base strip and being engageable with each other; bonding the first base strip and the second base strip respectively to a first area and a second area of a film that are opposed to each other; forming a container body by cutting the film; and forming a hinge at at least one position that satisfies m/n<0.25, where “n” represents a length of an opening portion of the container body, and “m” represents a distance from the hinge to an inner end portion of the opening portion in a longitudinal direction of the zipper tape.
[11] In the method according to [10], the forming of the hinge is executed between the feeding of the zipper tape and the bonding of the first base strip and the second base strip respectively to the first area and the second area.
[12] In the method according to [10], the forming of the hinge is executed after the bonding of the first base strip and the second base strip respectively to the first area and the second area.
[13] The method according to [12] further includes bonding the first area and the second area with each other in a bonding region at each of both ends in a longitudinal direction of the zipper tape, in which in the forming of the container body, the film is cut along the bonding region, and the forming of the hinge includes forming the hinge by a forming unit that is disposed across the bonding region.
[14] In the method according to any one of [10] to [13], the feeding of the zipper tape includes guiding the zipper tape with use of a guide member having a tubular shape.
[15] According to still another aspect of the invention, a device of manufacturing a container provided with a zipper tape includes: a unit configured to feed a zipper tape including a first base strip, a second base strip, a first engagement portion, and a second engagement portion, the first engagement portion and the second engagement portion respectively protruding from the first base strip and the second base strip and being engageable with each other; a unit configured to bond the first base strip and the second base strip respectively to a first area and a second area of a film that are opposed to each other; a unit configured to form a container body by cutting the film; and a unit configured to form a hinge at at least one position that satisfies m/n<0.25, where “n” represents a length of an opening portion of the container body, and “m” represents a distance from the hinge to an inner end portion of the opening portion in a longitudinal direction of the zipper tape.
[16] In the device according to [15], the unit configured to feed the zipper tape includes a guide member having a tubular shape and configured to guide the zipper tape inside the guide member.
[17] In the device according to [16], the unit configured to bond the first base strip and the second base strip respectively to the first area and the second area of the film that are opposed to each other does not include a plate to be interposed between the first base strip and the second base strip.
[18] The device according to any one of [15] to [17] further includes a unit configured to bond the first area and the second area with each other in a bonding region at each of both ends in a longitudinal direction of the zipper tape, in which the unit configured to form the container body cuts the film along the bonding region, and the unit configured to form the hinge has a forming unit that is disposed across the bonding region.

In the exemplary embodiment, the hinge is provided at at least one position that satisfies m/n<0.25, where “n” represents the length of the opening portion of the container body, and “m” represents the distance from the hinge to the inner end portion of the opening portion in the longitudinal direction of the zipper tape. The base strips of the zipper tape are bonded to each other and fixed in that state in the bonding region. Thus, the engagement strength of the engagement portions is relatively higher in a part close to the bonding region in the longitudinal direction of the zipper tape than in the other part. Providing the hinge at the above-described position makes it possible to compensate for a decrease in the engagement strength due to change in shapes of the engagement portions at the hinge, because the engagement strength in each of the respective sections on both sides of the hinge is relatively high. It is therefore possible to prevent the engagement strength in the hinge from being relatively weak in the bag provided with a zipper tape.

### BRIEF DESCRIPTION OF DRAWINGS

FIG. 1 is a plan view of a bag provided with a zipper tape according to a first exemplary embodiment of the invention.

FIG. 2 is a cross-sectional view taken along a line II-II of the bag provided with a zipper tape illustrated in FIG. 1.

FIG. 3 is a diagram for describing a thin portion to be provided in the bag provided with a zipper tape and action thereof in the exemplary embodiment.

FIG. 4 is a plan view of a bag provided with a zipper tape according to a second exemplary embodiment of the invention.

FIG. 5 is a plan view of a bag provided with a zipper tape according to a third exemplary embodiment of the invention.

FIG. 6 is a cross-sectional view of an example of a zipper tape that prevents unintended opening.

FIG. 7 is a cross-sectional view illustrating another example of the zipper tape.

FIG. 8 is a perspective view of a three-side-seal bag-making machine that manufactures a bag provided with a zipper tape according to an exemplary embodiment of the invention.

FIG. 9 is a diagram illustrating an example of a hinge forming unit according to an exemplary embodiment of the invention.

FIG. 10 is a diagram illustrating an example of a guide member according to an exemplary embodiment of the invention.

FIG. 11 is a diagram illustrating an example of a guide member according to an exemplary embodiment of the invention.

### DESCRIPTION OF EMBODIMENT(S)

The following describes preferred exemplary embodiments of the invention in detail with reference to the accompanying drawings. It is to be noted that, in this description and the accompanying drawings, components that have substantially the same functional configuration are indicated by the same reference signs, and thus redundant description thereof is omitted.

### First Exemplary Embodiment

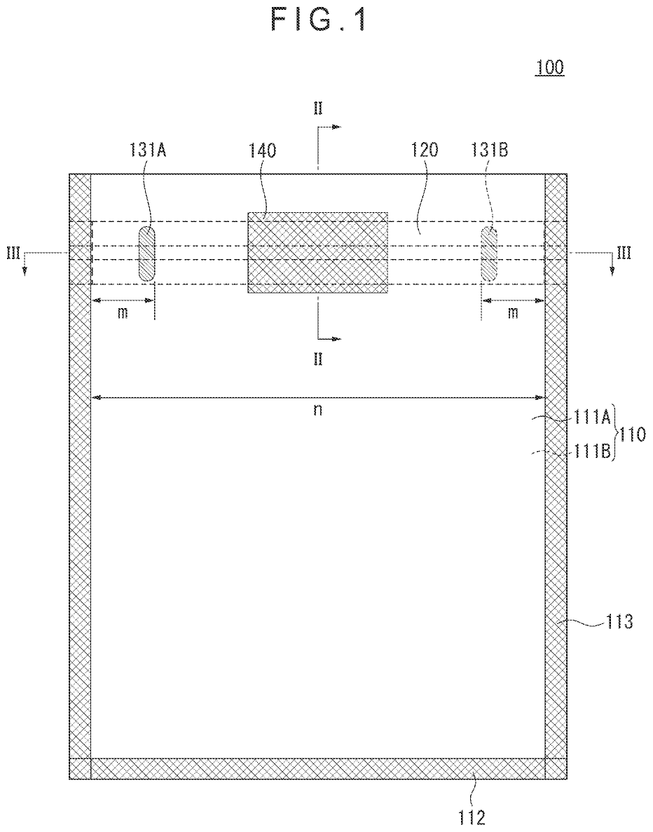

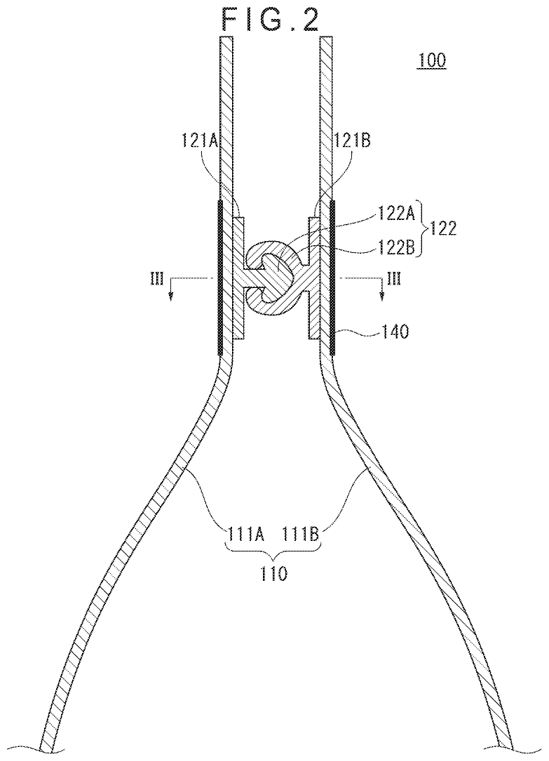

FIG. 1 is a plan view of a bag provided with a zipper tape according to a first exemplary embodiment of the invention. FIG. 2 is a cross-sectional view taken along a line II-II of the bag provided with a zipper tape illustrated in FIG. 1.

As illustrated in FIG. 1 and FIG. 2, a bag provided with a zipper tape 100 includes a film 110 and a zipper tape 120. The film 110 is formed into a bag body. The bag body includes a first area 111A and a second area 111B that are opposed to each other. The zipper tape 120 includes a base strip 121A that is at least partially bonded to the first area 111A, a base strip 121B that is at least partially bonded to the second area 111B, and a pair of engagement portions 122 (engagement portions 122A and 122B). The engagement portions 122A and 122B respectively protrude from the base strips 121A and 121B, and are engageable with each other.

The film 110 includes, for example, a single-layer or multi-layer thermoplastic resin. Specifically, a thermoplastic resin may be low density polyethylene (LDPE), linear low density polyethylene (LLDPE), or polypropylene (PP). PP may be a polypropylene homopolymer (HPP), a polypropylene random copolymer (RPP), or a polypropylene block copolymer (BPP). In a case where the film 110 includes a multi-layered film, biaxially oriented polypropylene (OPP), biaxially oriented polyethylene terephthalate (OPET), or biaxially oriented nylon (ONy) may be used for a surface base. These are each not limited to a resin derived from a fossil fuel, and may each be an environmentally friendly bio-plastic or a mixture of the resin derived from the fossil fuel and the bio-plastic. Examples of the bio-plastic preferably include bio-polyethylene. Further, the film 110 may include a layer of a metal material such as aluminum, or a layer of an inorganic material. For example, the film 110 may include a monomaterial resin composition which includes polyethylene as a main component, as with the zipper tape 120. This enables achievement of an environmentally friendly configuration having excellent recyclability.

The film 110 has a thickness of, for example, 20 μm or more, preferably 35 μm or more, more preferably 50 μm or more. Further, the film 110 has a thickness of, for example, 300 μm or less, preferably 200 μm or less, more preferably 180 μm or less.

In the exemplary embodiment, the first area 111A and the second area 111B may be formed by stacking two films 110, and bonding the two films 110 to each other at a bottom seal 112 and side seals 113. However, in another exemplary embodiment, for example, one film 110 may be folded at a part corresponding to the bottom seal 112 and bonded at the side seals 113. The side seal 113 is a bonding region which is provided at each of both ends in a longitudinal direction of the zipper tape 120, and in which the first area 111A, the base strips 121A and 121B of the zipper tape 120, and the second area 111B are stacked in this order and bonded to each other.

Further, a part in which the film is folded inward, that is, a so-called gusset, may be provided in a part corresponding to the bottom seal 112 or the side seal 113. In this case, the gusset may include the same film as that of the first area 111A or the second area 111B, or may include another film that is different therefrom. The bag provided with a zipper tape 100 may also be a stand up pouch which is able to be placed upright by the gusset being provided at a bottom of the bag provided with a zipper tape 100.

In the exemplary embodiment, the bag body has a mouth by being provided with the bottom seal 112 and the side seal 113 but not being provided with a top seal. However, in another exemplary embodiment, the top seal may be provided in addition to the bottom seal and the side seal, and the mouth may be provided afterward in the bag body by cutting between the top seal and the zipper tape.

In still another exemplary embodiment, the bag provided with a zipper tape may be provided in a state in which the bottom seal on an opposite side from the zipper tape is not provided. In this case, the bottom seal is formed after the bag is filled with contents. In addition, it is possible to apply the invention to a bag provided with a zipper tape having various known configurations.

The zipper tape 120 is formed, for example, by extrusion molding of a polyolefin-based resin. More specifically, the zipper tape 120 may include low density polyethylene (LDPE), linear low density polyethylene (LLDPE), or polypropylene (PP). PP may be a polypropylene homopolymer (HPP), a polypropylene random copolymer (RPP), or a polypropylene block copolymer (BPP). These are each not limited to a resin derived from a fossil fuel, and may each be an environmentally friendly bio-plastic or a mixture of the resin derived from the fossil fuel and the bio-plastic. Examples of the bio-plastic preferably include bio-polyethylene. To the material of the zipper tape 120, a known additive such as a stabilizer, an antioxidant, a lubricant, an antistatic agent, or a colorant may be added as necessary.

The zipper tape 120 may include a monomaterial resin composition which includes polyethylene as a main component. In this case, the zipper tape 120 as a whole includes the resin composition which includes polyethylene as the main component. Here, the main component is a component that occupies a predetermined percentage or more of the resin composition, and a content of the component is usually 50 mass % or more, preferably 70 mass % or more, more preferably 90 mass % or more, still more preferably 95 mass % or more, still further more preferably 98 mass % or more, and yet still further more preferably 100%. However, even in the case where the content of the main component is 100%, mixing of an additive and impurities is acceptable. The main component is confirmable by, for example, an IR method. The zipper tape 120 including the monomaterial resin composition which includes polyethylene as the main component enables an environmentally friendly configuration having excellent recyclability. Further, using bio-polyethylene as polyethylene makes it possible to achieve an environmentally friendly configuration which is further excellent in recyclability.

It is to be noted that, in the zipper tape 120, the shapes of the engagement portions 122A and 122B are not limited to the illustrated example, and it is possible to employ various shapes of engagement portions of known zippers having a combination of a claw shape, a hook shape, a knob shape, or the like. In the illustrated example, the engagement portion 122A has a male shape and the engagement portion 122B has a female shape; however, the engagement portions 122A and 122B may be the other way around. In addition, although a pair of engagement portions is disposed in the illustrated example, a plurality of pairs of engagement portions may be disposed.

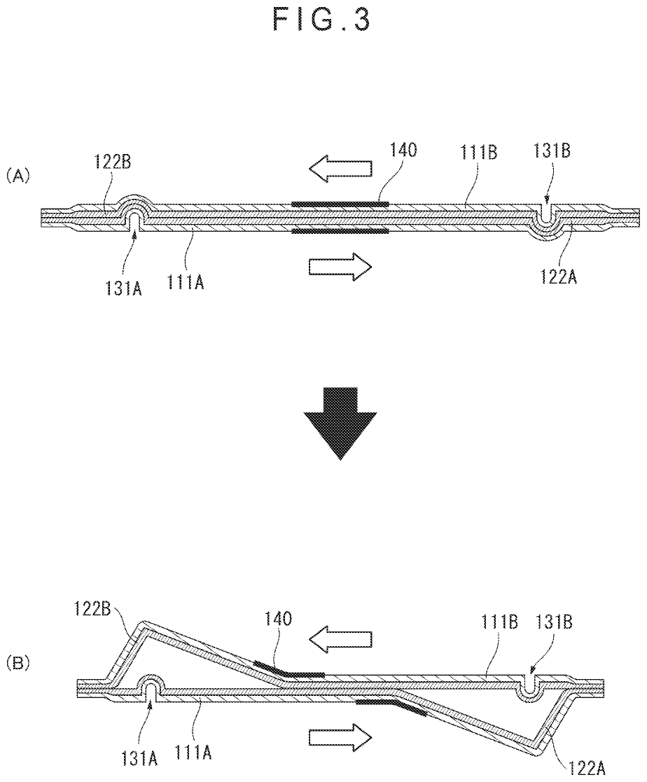

FIG. 3 is a diagram for describing a thin portion to be provided in the bag provided with a zipper tape and action thereof in the exemplary embodiment. It is to be noted that FIG. 3 is a cross-sectional view taken along a line III-Ill of the bag provided with a zipper tape illustrated in FIG. 1 and FIG. 2. As illustrated in FIG. 1 and (A) of FIG. 3, the bag provided with a zipper tape 100 according to the exemplary embodiment is provided with thin portions 131A and 131B at a part including the engagement portions 122 of the zipper tape 120. The thin portions 131A and 131B are formed by thinning the engagement portions 122A and 122B of the zipper tape 120 together with the base strips 121A and 121B and the film 110 forming the bag body by a pressing process to be described later, for example.

In the exemplary embodiment, the engagement portions 122A and 122B each having an irregular cross sectional profile in the zipper tape 120 are thinned, whereby the thin portions 131A and 131B each serve as a hinge of the zipper tape 120. Herein, the hinge means a point at which a deflection angle of the zipper tape 120 becomes discontinuous due to no or relatively weakened bending moment being transmitted to the longitudinal direction of the zipper tape 120. Accordingly, the zipper tape 120 is easily bendable at the hinge.

As illustrated in (A) of FIG. 3, in the exemplary embodiment, such a hinge is provided at each of two positions in the longitudinal direction of the zipper tape 120. The hinges are provided as the thin portions 131A and 131B. Here, the thin portions 131A and 131B are provided at respective positions close to the both ends in the longitudinal direction of the zipper tape 120.

Here, the thin portions 131A and 131B are each provided at a position that satisfies m/n<0.25, where “n” represents a length of the opening portion of the bag body, and “m” represents a distance to an inner end portion of the opening portion (one of both ends of a section of the length n) in the longitudinal direction of the zipper tape. The value of m/n is preferably 0.22 or less, more preferably 0.20 or less, still more preferably 0.16 or less, and yet still more preferably 0.12 or less. A lower limit of m/n may be 0, but is preferably 0.01 or more, more preferably 0.03 or more, and still more preferably 0.05 or more. Setting the value of m/n within this range makes it possible to achieve both openability and a function of preventing unintended opening with higher accuracy. Here, the length n of the opening portion of the bag body is, for example, 30 mm or more, preferably 50 mm or more, and more preferably 70 mm or more. Further, the length n of the opening portion of the bag body is, for example, 500 mm or less, preferably 400 mm or less, and more preferably 350 mm or less.

The thin portions 131A and 131B may each be provided at a position where the distance m to the side seal 113 that is the bonding region is 20 mm or less in the longitudinal direction of the zipper tape 120. Here, the distance m is a distance from an end edge of the side seal 113 on a side closer to a corresponding one of the thin portions 131A and 131B to an end edge of the corresponding one of the thin portions 131A and 131B on an opposite side from the relevant side seal 113. In other words, a region in which each of the thin portions 131A and 131B is to be provided is within a range of the distance m from the end edge of the side seal 113 on the closer side. The distance m is preferably 18 mm or less, more preferably 15 mm or less, and still more preferably 12 mm or less. Further, the distance m may be 0 mm; however, from the viewpoint of openability, the distance m is preferably 3 mm or more, more preferably 5 mm or more, and still more preferably 7 mm or more. The values of the distances m may be the same as or different from each other.

As illustrated in (B) of FIG. 3, providing such thin portions 131A and 131B allows, when the first area 111A and the second area 111B of the film 110 are slid alternately along the longitudinal direction of the zipper tape 120 at or near the midpoint between the thin portions 131A and 131B: the engagement portion 122B to separate from the engagement portion 122A and to bend in the thin portion 131A; and the engagement portion 122A to separate from the engagement portion 122B and to bend in the thin portion 131B. As a result, the engagement portion 122A and the engagement portion 122B are disengaged in the vicinity of each of the thin portions 131A and 131B. For example, putting a finger or the like in the opening portion formed in the vicinity of one of the thin portions 131A and 131B and pulling apart the opening portion at this time makes it possible to disengage the engagement portions 122A and 122B over an entire part of the zipper tape 120, and to open the bag provided with a zipper tape 100.

Further, in order to facilitate the above-described opening operation, an antislip structure 140 may be provided as illustrated in FIG. 1, on a surface, of each of the first area 111A and the second area 111B, opposed to a surface to which corresponding one of the base strips 121A and 121B of the zipper tape 120 is bonded. The antislip structure 140 is provided, as in the illustrated example, between two positions where the thin portions 131A and 131B are provided. Alternatively, the antislip structure 140 may be provided over the entire length of the zipper tape 120 including, for example, the thin portions 131A and 131B. The antislip structure 140 may specifically be based on a roughening process or an embossing process to increase a coefficient of friction between the film 110 and a finger of the user, an adhesive process, or the like.

In the exemplary embodiment, the thin portions 131A and 131B are each provided at the position that satisfies m/n<0.25, where “n” represents the length of the opening portion of the bag body, and “m” represents the distance to the inner end portion of the opening portion in the longitudinal direction of the zipper tape. In the side seal 113 that serves as the inner end portion of the opening portion, the base strips 121A and 121B of the zipper tape 120 are bonded to each other and fixed in that state. Thus, engagement strength of the engagement portions 122 is relatively higher in a part close to the side seal 113 in the longitudinal direction of the zipper tape 120 than in the other part. Providing the thin portions 131A and 131B at the above-described positions makes it possible to compensate for a decrease in the engagement strength due to change in shapes of the engagement portions 122 at the thin portions 131A and 131B, because the engagement strength in each of the respective sections on both sides of the thin portions 131A and 131B is relatively high. It is therefore possible in the exemplary embodiment to prevent the engagement strength in the thin portions 131A and 131B from being relatively weak in the bag provided with a zipper tape 100.

Specifically, for example, if the engagement strength of the zipper tape 120 in a section that includes neither the thin portion 131A nor the thin portion 131B is 26 N/50 mm or more, it is possible to prevent the unintended opening of the bag provided with a zipper tape 100 starting from the thin portions 131A and 131B. The engagement strength of the zipper tape 120 in the section that includes neither the thin portion 131A nor the thin portion 131B is preferably 30 N/50 mm or more, more preferably 40 N/50 mm or more. The engagement strength is measurable, for example, using a digital force gauge (available from Imada Corporation) as follows. First, the base strips 121A and 121B are each held at a part 2 mm away from the engagement portion of the zipper tape that is cut into a length of 50 mm in the longitudinal direction. Thereafter, while the base strip 121A is fixed, the base strip 121B is pulled up to measure strength until the engagement portions 122 are disengaged. A measurement result of a maximum load is given as the engagement strength. If the length in the longitudinal direction is less than 50 mm, and the length is X mm, it is possible to convert the engagement strength into N/50 mm by multiplying the measurement result N/X mm by 50/X.

### Second Exemplary Embodiment

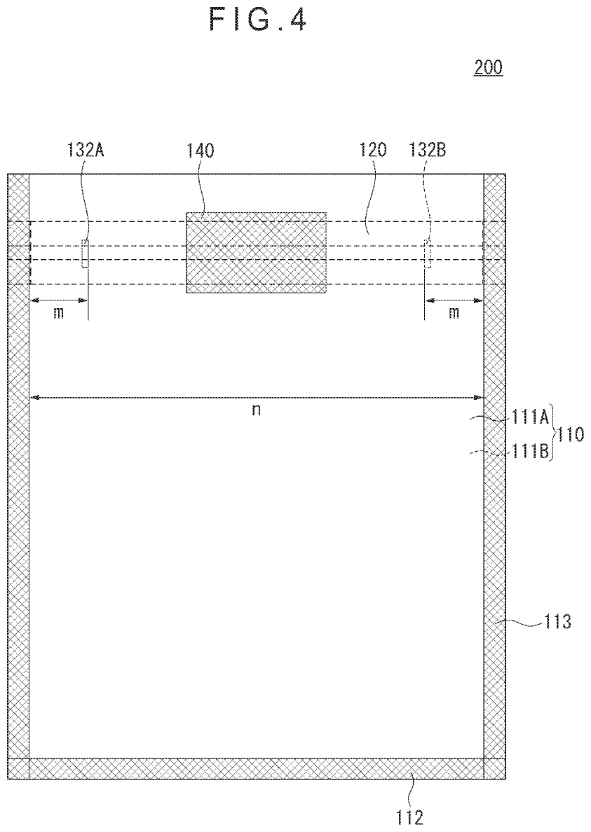

FIG. 4 is a plan view of a bag provided with a zipper tape according to a second exemplary embodiment of the invention. As illustrated in the figure, a bag provided with a zipper tape 200 according to the exemplary embodiment is provided with cuts 132A and 132B in respective parts including the engagement portions 122 of the zipper tape 120. In the illustrated example, the cuts 132A and 132B are provided on respective both surfaces of the bag provided with a zipper tape 200. Specifically, the cut 132A is formed from the first area 111A of the film 110 to the base strip 121A and the engagement portions 122A and 122B of the zipper tape 120, and the cut 132B is formed from the second area 111B of the film 110 to the base strip 121B and the engagement portions 122A and 122B of the zipper tape 120. It is to be noted that configurations of the bag provided with a zipper tape 200 other than those described above are the same as those of the bag provided with a zipper tape 100 according to the first exemplary embodiment described above.

In the exemplary embodiment, the cuts 132A and 132B each serve as the hinge of the zipper tape 120. The cuts 132A and 132B reach the engagement portions 122A and 122B each having the irregular cross sectional profile in the zipper tape 120. As already described above in the first exemplary embodiment, the zipper tape 120 is easily bendable at the hinge. As with the first exemplary embodiment, the cuts 132A and 132B are provided at respective positions close to the both ends in the longitudinal direction of the zipper tape 120. Specifically, the cuts 132A and 132B are each provided at the position where the distance m to the side seal 113 that is the bonding region is 20 mm or less in the longitudinal direction of the zipper tape 120. The distance m is defined similarly to that in the first exemplary embodiment, and a region in which each of the cuts 132A and 132B is to be provided is within a range of the distance m from the end edge of the side seal 113 on the closer side.

As with the first exemplary embodiment, also in the above-described second exemplary embodiment of the invention, the cuts 132A and 1328 with which the zipper tape 120 is provided each function as the hinge, which makes it easier to bend any one of the engagement portion 122A or 1228 of the zipper tape 120 at the cuts 132A and 132B, even in a case where the zipper tape 120 includes a material having relatively high rigidity. Further, also in the exemplary embodiment, the cuts 132A and 1328 are each provided at the position that satisfies m/n<0.25, where “n” represents the length of the opening portion of the bag body, and “m” represents the distance to the inner end portion of the opening portion in the longitudinal direction of the zipper tape. This makes it possible to compensate for the decrease in the engagement strength caused by lack of the engagement portions 122 at the cuts 132A and 1328. It is therefore possible in the exemplary embodiment to prevent the engagement strength in the cuts 132A and 1328 from being relatively weak in the bag provided with a zipper tape 200.

### Third Exemplary Embodiment

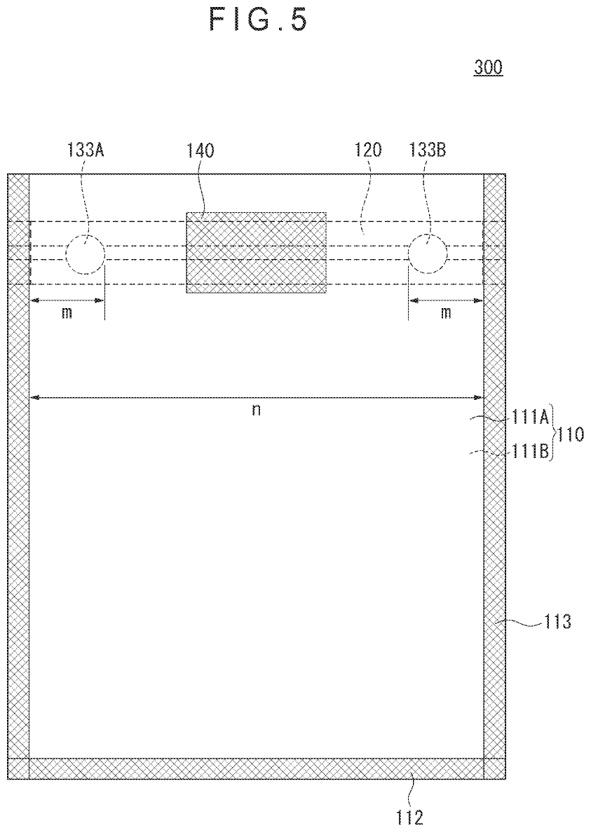

FIG. 5 is a plan view of a bag provided with a zipper tape according to a third exemplary embodiment of the invention. As illustrated in the figure, a bag provided with a zipper tape 300 according to the exemplary embodiment is provided with punched holes 133A and 1338 in respective parts including the engagement portions 122 of the zipper tape 120. In the illustrated example, the punched holes 133A and 133B are each provided in such a manner as to penetrate through the zipper tape 120. Specifically, the punched holes 133A and 1338 are formed through the base strip 121A, the engagement portions 122A and 122B, and the base strip 121B, of the zipper tape 120, for example, by a process to be performed prior to bonding the zipper tape 120 to the film 110, as described below. It is to be noted that configurations of the bag provided with a zipper tape 300 other than those described above are the same as those of the bag provided with a zipper tape 100 according to the first exemplary embodiment described above.

In the exemplary embodiment, the punched holes 133A and 133B each serve as the hinge of the zipper tape 120. The punched holes 133A and 133B penetrate through the engagement portions 122A and 122B each having the irregular cross sectional profile in the zipper tape 120. As already described above in the first exemplary embodiment, the zipper tape 120 is easily bendable at the hinge. As with the first exemplary embodiment, the punched holes 133A and 133B are provided at respective positions close to the both ends in the longitudinal direction of the zipper tape 120. Specifically, the punched holes 133A and 133B are each provided at the position where the distance m to the side seal 113 that is the bonding region is 20 mm or less in the longitudinal direction of the zipper tape 120. The distance m is defined similarly to that in the first exemplary embodiment, and a region in which each of the punched holes 133A and 133B is to be provided is within a range of the distance m from the end edge of the side seal 113 on the closer side.

As with the first exemplary embodiment, also in the above-described third exemplary embodiment of the invention, the punched holes 133A and 133B with which the zipper tape 120 is provided each serve as the hinge, which makes it easier to bend any one of the engagement portion 122A or 122B of the zipper tape 120 at the punched holes 133A and 133B, even in a case where the zipper tape 120 includes a material having relatively high rigidity. Further, also in the exemplary embodiment, the punched holes 133A and 133B are each provided at the position that satisfies m/n<0.25, where “n” represents the length of the opening portion of the bag body, and “m” represents the distance to the inner end portion of the opening portion in the longitudinal direction of the zipper tape. This makes it possible to compensate for the decrease in the engagement strength caused by lack of the engagement portions 122 at the punched holes 133A and 133B. It is therefore possible in the exemplary embodiment to prevent the engagement strength in the punched holes 133A and 1338 from being relatively weak in the bag provided with a zipper tape 300.

In the above exemplary embodiments, the examples have been described in which the hinge is provided at each of two positions that satisfy m/n<0.25 at the both ends of the zipper tape, where “n” represents the length of the opening portion of the bag body, and “m” represents the distance from the hinge to the inner end portion of the opening portion in the longitudinal direction of the zipper tape. However, the hinge may be provided only at one position at one of the both ends of the zipper tape. In the above exemplary embodiments, the examples have been described in which a container body has a bag shape. However, a container including the zipper tape and a container body other than the bag-shaped container body may be provided.

Example of Zipper Tape that Prevents Unintended Opening

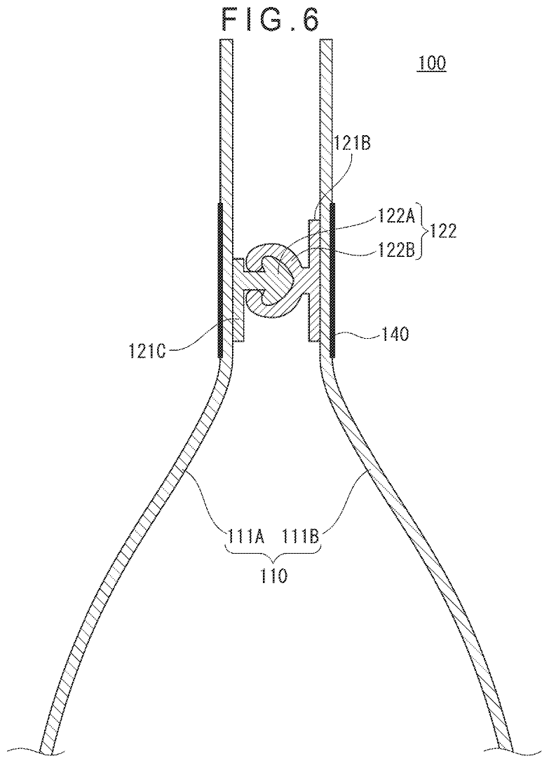

FIG. 6 is a cross-sectional view of an example of a zipper tape that prevents unintended opening and is employable in the above-described first to third exemplary embodiments, for example. In the illustrated example, a base strip 121C on a side of the engagement portion 122A having a male shape does not extend toward a side close to a mouth relative to the engagement portion 122A in a width direction of the zipper tape. Thus, the base strip 121C is not bonded to the first area 111A of the film 110 on a side close to the mouth relative to the engagement portion 122A in the width direction of the zipper tape. As a result, it is not possible to apply force in a direction of disengaging the engagement portions 122 even if the film 110 is gripped on a side close to the mouth relative to the zipper tape. This makes it difficult to open the bag provided with a zipper tape 100 by an ordinary method. Even in such a case, it is possible to open the bag provided with a zipper tape 100 by the method described above with reference to FIG. 3. Accordingly, the configuration of the zipper tape as illustrated in FIG. 6 is effective for preventing the unintended opening of the bag provided with a zipper tape 100.

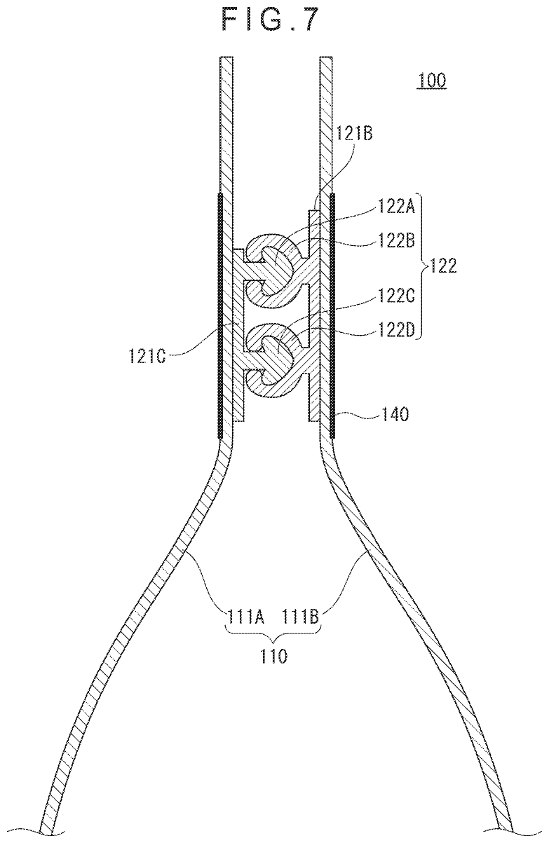

FIG. 7 is a cross-sectional view illustrating another example of the zipper tape. For example, the zipper tape as illustrated in FIG. 6 may further be provided with engagement portions 122C and 122D. The engagement portions 122C and 122D respectively protrude from the base strips 121C and 121B, and are engageable with each other. In this case, the zipper tape is engaged by the two sets of engagement portions, i.e., the set of the engagement portions 122A and 122B and the set of the engagement portions 122C and 122D. This makes it possible to increase the engagement strength. Such a configuration is effective in a case where, as in the illustrated example, the base strip 121C on one side is not bonded to the first area 111A of the film 110 on a side close to the mouth relative to the engagement portion 122A in the width direction of the zipper tape to make the opening difficult. However, such a configuration may be employed in a case where, as in the example illustrated in FIG. 2, the both base strips are bonded to the film on the both sides in the width direction. As for the engagement portions 122C and 122D also, it is preferable to provide the hinges such as the thin portions 131A and 131B, the cuts 132A and 132B, or the punched holes 133A and 133B described above, from the viewpoint of openability; however, in order to achieve both high sealability and openability, it is also possible to provide the hinges only to the engagement portions 122A and 122B on a side close to the mouth, not to the engagement portions 122C and 122D on a side close to containing space. Alternatively, in contrast to the illustrated example, it is also possible to dispose the engagement portions 122C and 122D not provided with the hinges on the close to the mouth, and dispose the engagement portions 122A and 122B provided with the hinges on the side close to containing space. Further, in a case where both the set of the engagement portions 122A and 122B and the set of the engagement portions 122C and 122D are each provided with the hinges, the values of m of the both sets may be different; however, the values of m of both sets are preferably the same from the viewpoint of achieving smoother openability.

Method of Manufacturing Bag Provided with Zipper Tape

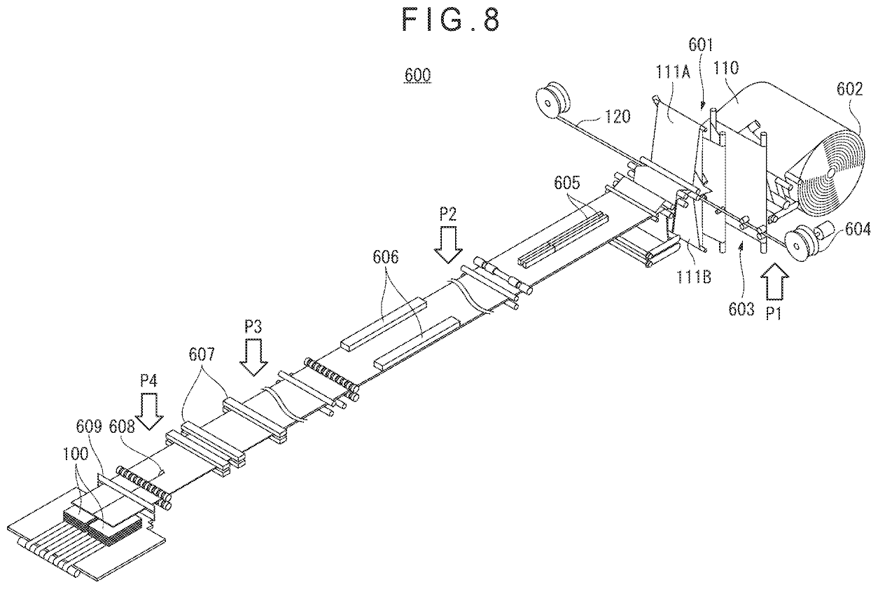

FIG. 8 is a perspective view of a three-side-seal bag-making machine that manufactures a bag provided with a zipper tape according to an exemplary embodiment of the invention. As illustrated in the figure, in a three-side-seal bag-making machine 600, a film feeder 601 unwinds a film 110 wound around a film roll 602, and a cutting blade (not illustrated) cuts the film 110 in a width direction to form a pair of portions (the first area 111A and the second area 111B) that are opposed to each other. Meanwhile, a tape feeder 603 unwinds the zipper tape 120 wound around a tape roll 604, and feeds the zipper tape 120 to a predetermined position between the first area 111A and the second area 111B of the film 110 using a guide member (not illustrated). A seal bar 605 bonds the base strips 121A and 121B of the zipper tape 120 to the first area 111A and the second area 111B of the film 110, respectively. Used for the bonding is, for example, heat sealing, welding by ultrasonic waves, or adhesion using an adhesive.

In the film 110 to which the zipper tape 120 has been bonded, a seal bar 606 forms the bottom seal 112 between the first area 111A and the second area 111B, and a seal bar 607 similarly forms the side seal 113. A cutting blade 608 cuts the film 110 in a longitudinal direction along the bottom seal 112, and a cutting blade 609 cuts the film 110 in a width direction along the bottom seal 112. Through those processes of forming the film 110 into the bag body, the bag provided with a zipper tape 100 is manufactured. This applies similarly to the bags provided with zipper tapes 200 and 300 according to the second and third exemplary embodiments.

Here, FIG. 8 does not illustrate a unit configured to form the hinges such as the thin portions 131A and 131B, the cuts 132A and 132B, or the punched holes 133A and 133B in the zipper tape 120. The hinge forming unit is disposed, for example, at any of parts indicated by arrows P1 to P4 illustrated in FIG. 8. The arrow P1 is a position between the tape feeder 603 that feeds the zipper tape 120 and the seal bar 605 that bonds the base strips 121A and 121B of the zipper tape 120 to the first area 111A and the second area 111B of the film 110. The arrow P2 is a position in a subsequent stage of the seal bar 605 and a preceding stage of the seal bar 606 that forms the bottom seal 112. The arrow P3 is a position in a subsequent stage of the seal bar 606 and a preceding stage of the seal bar 607 that forms the side seal 113, and the arrow P4 is a position in a subsequent stage of the seal bar 607.

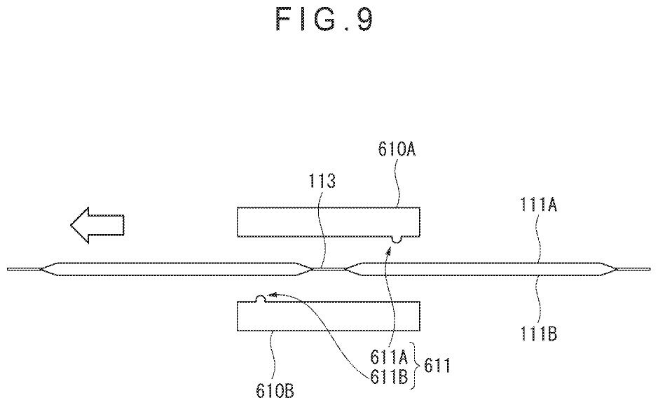

FIG. 9 is a diagram illustrating an example of a hinge forming unit according to an exemplary embodiment of the invention. In the illustrated example, in the position of the arrow P4 illustrated in FIG. 8, i.e., in the position in which the side seal 113 has already been formed between the first area 111A and the second area 111B of the film 110, pressing members 610A and 610B including protrusions 611 (protrusions 611A and 611B) press the first area 111A and the second area 111B from both sides, whereby the thin portions 131A and 131B of the bag provided with a zipper tape 100 according to the first exemplary embodiment are formed. Performing such a pressing process makes it possible to reduce the thickness of the engagement portions 122 of the zipper tape 120 while maintaining the shapes of the engagement portions 122, and to form the thin portions 131A and 131B while maintaining a sealing function of the zipper tape 120.

In the illustrated example, the pressing members 610A and 610B are disposed across the side seal 113 prior to the film 110 being cut along the side seal 113. This makes it possible to effectively form the thin portions 131A and 131B in a case where the thin portions 131A and 131B are each to be provided at a position close to the side seal 113, specifically, in a case where the thin portions 131A and 131B are each to be formed at the position that satisfies m/n<0.25, where “n” represents the length of the opening portion of the bag body, and “m” represents the distance to the inner end portion of the opening portion in the longitudinal direction of the zipper tape. For example, it is possible to use the same pressing members 610A and 610B to form the thin portions 131A and 131B even in a case where the bag provided with a zipper tape 100 is changed in width. In other words, in the exemplary embodiment, forming the hinges such as the thin portions 131A and 131B closer to the end portions allows a distance from one of the end portions of the bag body to the corresponding one of the hinges to be constant if the width of the bag provided with a zipper tape 100 does not change greatly. This makes it possible to form the hinges with the same jig regardless of the width of the bag. In another example, the hinges may be formed by different jigs depending on the width of the bag provided with a zipper tape 100, or the hinges on the both sides may be formed by respective jigs that are different from each other.

The thin portions 131A and 131B are formed by the protrusions 611 in the above-described example. Similarly, it is possible to form the cuts 132A and 132B of the bag provided with a zipper tape 200 according to the second exemplary embodiment by providing cut blades in place of the protrusions 611. Further, it is possible to form the punched holes 133A and 133B of the bag provided with a zipper tape 300 according to the third exemplary embodiment by providing punches in place of protrusions 611 and providing die holes having shapes corresponding to the punches at respective positions that are opposed to the punches. In the illustrated example, the thin portion 131A is formed by being pressed from the first area 111A and the thin portion 131B is formed by being pressed from the second area 111B; however, both of the thin portions 131A and 131B may be formed by being pressed from the first area 111A, the second area 111B, or both.

In the above-described examples, the hinges are formed in the zipper tape 120 in the position of the arrow P4 illustrated in FIG. 8; however, it is also possible to form the hinges in any of the respective positions indicated by the arrows P1 to P3. For example, in a case where the hinges are to be formed in the position of the arrow P1, the zipper tape 120 is not bonded to the film 110 yet, which makes it possible to form the hinges in the zipper tape 120 without influencing the film 110. For example, in a case where the punched holes 133A and 133B as in the third exemplary embodiment are to be formed, it is preferable to form the zipper tape 120 before the zipper tape 120 is bonded to the film 110 in order to ensure strength and a sealing property of the bag body. In contrast, in a case where the hinges are to be formed in the positions of the arrows P2 to P4, the thin portions 131A and 131B or the cuts 132A and 132B, for example, are also formed in the film 110. The hinges are formed in a process close to a process of forming the side seal 113 between the first area 111A and the second area 111B, which helps to improve accuracy of alignment between the hinge and the side seal 113 (i.e., the end of the zipper tape 120).

It is to be noted that, although the bag provided with a zipper tape is manufactured by the three-side-seal bag-making machine in the above-described examples, it is not limited to the three-side-seal bag-making machine. In various other bag-making machines, the device as described with reference to FIG. 9 may be set in between feeding the zipper tape and bonding the zipper tape to the film, or in the subsequent stage of bonding the zipper tape to the film, which makes it possible to manufacture the bag provided with a zipper tape provided with the hinges in the zipper tape.

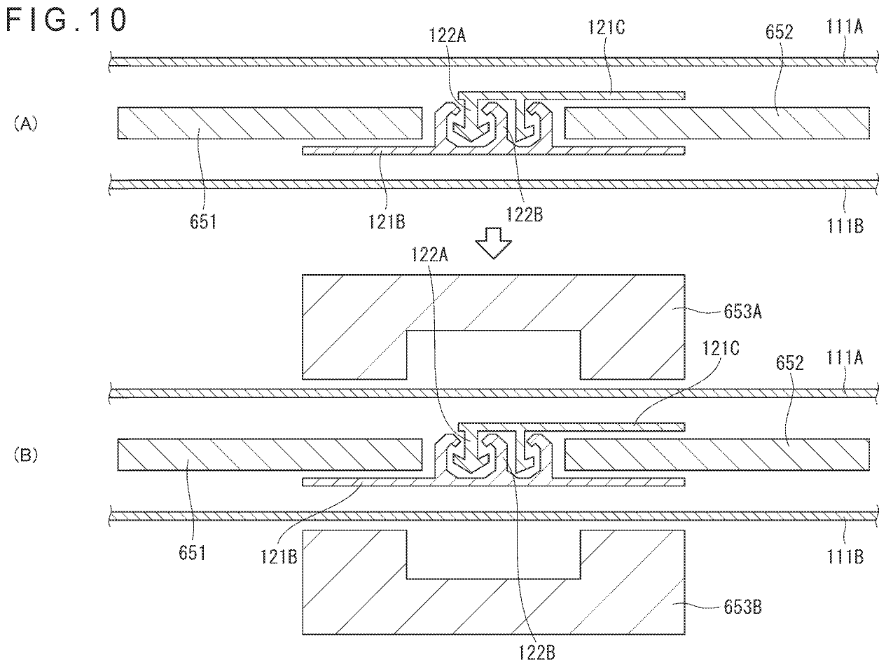

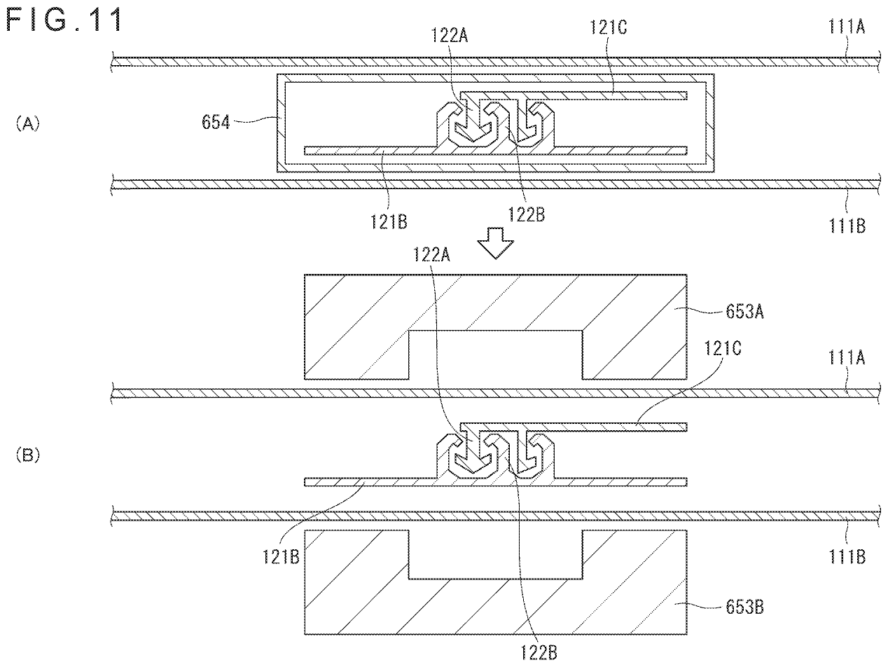

FIG. 10 and FIG. 11 are each a diagram illustrating an example of a device that guides the zipper tape according to an exemplary embodiment of the invention. It is to be noted that, although an exemplary zipper tape is illustrated in which one of the base strips, i.e., the base strip 121C, is not bonded to the first area 111A of the film 110 on a side close to the mouth relative to the engagement portion 122A as described above with reference to FIG. 6 in those figures, configurations illustrated in FIG. 10 and FIG. 11 are applicable to other zipper tapes. In each of the figures, (A) represents a configuration for guiding the zipper tape in a preceding stage of the seal bar 605 illustrated in FIG. 8, and (B) represents a configuration of a stage of the seal bar 605.

In the example illustrated in FIG. 10, as indicated in (A), the zipper tape is guided using plates 651 and 652 interposed between the first area 111A and the second area 111B of the film 110 and between the base strips 121B and 121C of the zipper tape. A position in the width direction of the engagement portions 122A and 122B of the zipper tape is fixed between the plate 651 and the plate 652. This makes it possible to perform positioning of the zipper tape with respect to the film 110. As indicated in (B), in the stage illustrated as the seal bar 605 in FIG. 8, a seal bar 653A sandwiches the first area 111A and the base strip 121C between the plates 651 and 652, and a seal bar 653B sandwiches the second area 111B between the plates 651 and 652, whereby the zipper tape is bonded to the film 110.

In contrast, in the example illustrated in FIG. 11, as indicated in (A), the zipper tape is guided inside a guide member 654 having a tubular shape disposed between the first area 111A and the second area 111B of the film 110. A position in the width direction of the base strip 121B is fixed between side walls of the guide member 654. This makes it possible to perform positioning of the zipper tape with respect to the film 110. As indicated in (B), in the stage illustrated as the seal bar 605 in FIG. 8, seal bars 653A and 653B sandwich the first area 111A and the second area 111B, and the base strips 121B and 121C which are disposed between the first area 111A and the second area 111B, whereby the zipper tape is bonded to the film 110.

The configuration illustrated in FIG. 11 may be effective, for example, in a case where the seal bars 653A and 653B do not have to sandwich a plate therebetween owing to conditions including, for example, sealing temperature. In addition, in a case where a flange protruding from the engagement portion 122A of one of the base strips, i.e., the base strip 121C, is short or not provided as in the illustrated example, it is possible to perform the positioning of the zipper tape more reliably by using the guide member 654 having the tubular shape than by using the plates 651 and 652. It is to be noted that the guide member 654 does not necessarily have to have a rectangular cross section as illustrated in the figure, and may have a polygonal cross section other than a rectangular cross section, or may have a U-shaped cross section in which an upper part or a lower part of the guide member 654 illustrated in the figure is opened, for example.

Preferred exemplary embodiments of the invention have been described above in detail with reference to the accompanying drawings, but the invention is not limited to such exemplary embodiments. It is apparent that a skilled person in the art of the invention can arrive at various alterations and modifications within the scope of the technical idea recited in the appended claims, and it is understood that such alterations and modifications naturally fall within the technical scope of the invention.

1. A container provided with zipper tape comprising:
a container body including at least a first area and a second area that are opposed to each other; and
a zipper tape including: a first base strip being at least partially bonded to the first area; a second base strip being at least partially bonded to the second area; and a first engagement portion and a second engagement portion respectively protruding from the first base strip and the second base strip and being engageable with each other, wherein
a hinge is provided at at least one position that satisfies m/n<0.25, where “n” represents a length of an opening portion of the container body, and “m” represents a distance from the hinge to an inner end portion of the opening portion in a longitudinal direction of the zipper tape.

2. The container according to claim 1, wherein the hinge is provided at a position where the distance m to the inner end portion of the opening portion is less than or equal to 20 mm.

3. The container according to claim 1, wherein engagement strength of the zipper tape in a part that does not include the hinge is more than or equal to 26 N/50 mm.

4. The container according to claim 1, wherein the hinge comprises a thin portion or a cut provided in the first engagement portion and the second engagement portion.

5. The container according to claim 1, wherein the hinge comprises a punched hole that penetrates through the first base strip, the second base strip, the first engagement portion, and the second engagement portion.

6. The container according to claim 1, wherein an antislip structure is provided on at least one of: a surface of the first area which is opposed to a surface to which the first base strip is bonded; or a surface of the second area which is opposed to a surface to which the second base strip is bonded.

7. The container according to claim 1, wherein
the container body has a mouth on one side in a width direction of the zipper tape, and
the first base strip is not bonded to the first area on a side close to the mouth relative to the first engagement portion in the width direction.

8. The container according to claim 1, wherein the zipper tape further comprises a third engagement portion and a fourth engagement portion respectively protruding from the first second base strip and the second base strip and being engageable with each other.

9. The container according to claim 1, wherein the container body has a bag shape.

10. A method of manufacturing a container provided with a zipper tape, the method comprising:
feeding a zipper tape including a first base strip, a second base strip, a first engagement portion, and a second engagement portion, the first engagement portion and the second engagement portion respectively protruding from the first base strip and the second base strip and being engageable with each other;
bonding the first base strip and the second base strip respectively to a first area and a second area of a film that are opposed to each other;
forming a container body by cutting the film; and
forming a hinge at at least one position that satisfies m/n<0.25, where “n” represents a length of an opening portion of the container body, and “m” represents a distance from the hinge to an inner end portion of the opening portion in a longitudinal direction of the zipper tape.

11. The method according to claim 10, wherein the forming of the hinge is executed between the feeding of the zipper tape and the bonding of the first base strip and the second base strip respectively to the first area and the second area.

12. The method according to claim 10, wherein the forming of the hinge is executed after the bonding of the first base strip and the second base strip respectively to the first area and the second area.

13. The method according to claim 12 further comprising:
bonding the first area and the second area with each other in a bonding region at each of both ends in a longitudinal direction of the zipper tape, wherein
in the forming of the container body, the film is cut along the bonding region, and
the forming of the hinge comprises forming the hinge by a forming unit that is disposed across the bonding region.

14. The method according to claim 10, wherein the feeding of the zipper tape comprises guiding the zipper tape with use of a guide member having a tubular shape.

15. A device of manufacturing a container provided with a zipper tape, the device comprising:
a unit configured to feed a zipper tape including a first base strip, a second base strip, a first engagement portion, and a second engagement portion, the first engagement portion and the second engagement portion respectively protruding from the first base strip and the second base strip and being engageable with each other;
a unit configured to bond the first base strip and the second base strip respectively to a first area and a second area of a film that are opposed to each other;
a unit configured to form a container body by cutting the film; and
a unit configured to form a hinge at at least one position that satisfies m/n<0.25, where “n” represents a length of an opening portion of the container body, and “m” represents a distance from the hinge to an inner end portion of the opening portion in a longitudinal direction of the zipper tape.

16. The device according to claim 15, wherein the unit configured to feed the zipper tape comprises a guide member having a tubular shape and configured to guide the zipper tape inside the guide member.

17. The device according to claim 16, wherein the unit configured to bond the first base strip and the second base strip respectively to the first area and the second area of the film that are opposed to each other does not include a plate to be interposed between the first base strip and the second base strip.

18. The device according to claim 15, further comprising: a unit configured to bond the first area and the second area with each other in a bonding region at each of both ends in a longitudinal direction of the zipper tape, wherein
the unit configured to form the container body cuts the film along the bonding region, and
the unit configured to form the hinge comprises a forming unit that is disposed across the bonding region.
